(19) United States
(12) Patent Application Publication
(10) Pub. No.: US 2023/0278054 A1
(43) Pub. Date: Sep. 7, 2023

(54) Pumping-Type Container

(71) Applicant: TAESUNG INDUSTRIAL CO., LTD., Anyang-si (KR)

(72) Inventor: Jong Hee LEE, Uiwang-si (KR)

(21) Appl. No.: 17/874,950

(22) Filed: Jul. 27, 2022

(30) Foreign Application Priority Data
Mar. 4, 2022 (KR) 10-2022-0028318

(51) Int. Cl. B05B 11/00

(52) U.S. Cl. CPC B05B 11/3023; B05B 11/3047; B05B 11/3067

(57) ABSTRACT

The present disclosure relates to a pumping-type container, and is to solve the problem of a discharge opening/closing part in which the force of pressing a button toward a cylinder is great and the assembly operation thereof is difficult. To this end, a discharge opening/closing part may be configured to have an elastic deformation opening/closing part which is made of an elastic material and has an opening/closing cutting line thereon, and is detachably coupled to the button such that the elastic deformation opening/closing part closes the end of the button discharge channel part.

### CROSS-REFERENCE TO RELATED APPLICATION(S)

This application is based upon and claims the benefit of priority from Korean Patent Application No. 10-2022-0028318, filed on Mar. 4, 2022 in the Korean Intellectual Property Office, the entire contents of which is incorporated herein by reference.

### BACKGROUND

### 1. Field

The present disclosure relates to a pumping-type container and, more particularly, to a container having a structure for discharging a liquid material stored in a container part in a pumping type.

### 2. Description of the Prior Art

There has been widespread use of pumping-type containers such that a liquid material such as cosmetics or shampoo is stored therein and then discharged, to be used, in a pumping type through button pressing operations.

Pumping-type containers have a problem in that a liquid material that has not been discharged is solidified by air introduced from the outside, thereby clogging the discharge path, or the liquid material is degenerated.

In order to solve such a problem, pumping-type containers have been used, which have a discharge opening/closing part configured to operate such that, when a liquid material is discharged to the outside, a button discharge channel part formed in a button is opened, and when discharge of the liquid material through the button discharge channel part is stopped, the button discharge channel part is closed.

FIG. 18 and FIG. 19 are main part cross-sectional views of a conventional pumping-type container, respectively, and FIG. 20 is a view showing a nozzle tube and a discharge opening/closing part according to a conventional pumping-type container.

As illustrated in the drawings, a conventional pumping-type container is configured to have a liquid material storage container 130 in which a liquid material is stored, a cylinder 151 installed inside the liquid material storage container 130, a button 160 which has a button discharge channel part formed therein and is installed in the liquid material storage container 130 so as to be able to descend toward the cylinder 151, a pumping part 170 configured to operate such that the liquid material stored in the liquid material storage container 130 is discharged to the outside through the button discharge channel part, and a discharge opening/closing part 180 configured to operate so as to open or close the button discharge channel part.

The liquid material storage container 130 is configured to have a storage space part (not shown) having a storage space for the liquid material, a container cap 132 coupled to the upper end of the storage space part (not shown), and a button raising/lowering guide tube part 133 formed on the upper surface of the container cap 132.

The cylinder 151 is configured to have a cylinder bottom part 151a having a through-hole 151c formed therethrough, and a cylinder side part 151b which is bent from the peripheral circumferential part of the cylinder bottom part 151a and has a tube shape.

The cylinder 151 is installed inside the storage space part (not shown) to be supported on the container cap 132.

The button 160 is configured to have a button side part 164 having a tube shape and a button ceiling part 161 formed at the upper end of the button side part 164 in addition to the button discharge channel part.

The button discharge channel part is configured to have a horizontal discharge channel part 163 and a vertical discharge channel part 162 formed on the button ceiling part 161.

The vertical discharge channel part 162 is formed to be disposed side by side with the button side part 164.

A support partition wall 165 is formed between the vertical discharge channel part 162 and the horizontal discharge channel part 163.

The support partition wall 165 has a partition wall discharge guide hole 165a formed therethrough.

The horizontal discharge channel part 163 has one end configured to protrude beyond the outer surface of the button side part 164, and the other end formed to be connected to the upper end of the vertical discharge channel part 162.

A nozzle tube 155 is installed at the end of the horizontal discharge channel part 163.

The button 160 is installed such that the lower end of the button side part 164 is inserted into the button raising/lowering guide tube part 133.

The pumping part 170 is configured to have a check valve 171 and a cylinder piston 172 installed inside the cylinder 151, a tubular pressing member 173 installed on the upper side of the cylinder piston 172, an opening/closing operation member 174 which has a tube shape and is installed inside the pressing member 173, and a button return spring 177 installed between the button 160 and the upper surface of the container cap 132.

The discharge opening/closing part 180 is configured to have a nozzle opening/closing member 181 installed inside of the nozzle tube 155, and an opening/closing member support spring 182 installed inside the nozzle tube 155.

The nozzle opening/closing member 181 is configured to have a nozzle opening/closing rod part 181a, an opening/closing member support flange 181b formed to extend from the outer surface of the nozzle opening/closing rod part 181a in a radial direction, and a spring support rod part 181c formed to extend from the rear end of the nozzle opening/closing rod part 181a.

The opening/closing member support flange 181b has multiple flange discharge guide holes 181d formed therethrough.

The nozzle opening/closing member 181 is installed such that the nozzle opening/closing rod part 181a closes the front end of the nozzle tube 155.

The opening/closing member support spring 182 is installed such that both ends thereof are supported by the rear end of the nozzle opening/closing rod part 181a and the support partition wall 165.

An operation of the conventional pumping-type container will be described with reference to FIG. 21 as follows.

First, the button 160 is pressed and thus descended toward the cylinder 151. An elastic force is accumulated in the button return spring 177 while the button 160 is descended.

And then, as the cylinder piston 172 is descended when the button 160 is descended, the inside of the cylinder 151 becomes a positive pressure state. The positive pressure state means a pressure state higher than atmospheric pressure.

When the inside of the cylinder 151 becomes a positive pressure state, the through-hole 151c is closed by the check valve 171, the liquid material stored in the cylinder 151 reaches the nozzle opening/closing rod part 181a via the opening/closing operation member 174, the pressing member 173, and the button discharge channel parts 162 and 163.

By the discharge pressure of the liquid material having reached the nozzle opening/closing rod part 181a, the nozzle opening/closing rod part 181a moves back toward the support partition wall 165. While the nozzle opening/closing rod part 181a moves back toward the support partition wall 165, an elastic force is accumulated in the opening/closing member support spring 182.

When the nozzle opening/closing rod part 181a moves back toward the support partition wall 165, the liquid material having reached the nozzle tube 155 is discharged to the outside (see FIG. 21).

Next, when the operation of pressing the button 160 is stopped, the button 160 is ascended by the elastic force accumulated in the button return spring 177.

And then, as the cylinder piston 172 ascends when the button 160 is ascended, the inside of the cylinder 151 becomes a negative pressure state. The negative pressure state means a pressure state lower than atmospheric pressure.

When the inside of the cylinder 151 becomes a negative pressure state, the discharge operation of the liquid material is stopped.

When the discharge operation of the liquid material is stopped, the discharge pressure of the liquid material is reduced so that the nozzle tube 155 is closed by the nozzle opening/closing member 181.

In addition, when the inside of the cylinder 151 becomes a negative pressure state, the through-hole 151c is opened, and thus the liquid material stored in the liquid material storage container 130 is introduced into the cylinder 151 through the through-hole 151c.

However, the conventional pumping-type container has a problem in that the force of pressing the button 160 toward the cylinder 151 increases since the button discharge channel parts 162 and 163 are opened by the operation in which the liquid nozzle opening/closing rod part 181a moves in a direction opposite to the direction in which the liquid material is discharged.

There is another problem in that it is difficult to assemble the discharge opening/closing part 180 because the discharge opening/closing part 180 is installed inside the horizontal discharge channel part 163.

### SUMMARY OF THE INVENTION

Therefore, it is an aspect of the present disclosure to provide a pumping-type container having a button that can be pressed toward a cylinder with a reduced force, and having a discharge opening/closing part that can be easily assembled.

In accordance with an aspect, the present disclosure provides a pumping-type container including a discharge opening/closing part, which has an elastic deformation opening/closing part made of an elastic material and having an opening/closing cutting line formed thereon and is detachably coupled to the button such that the elastic deformation opening/closing part closes the end of the button discharge channel part.

In addition, in order to prevent the discharge opening/closing member from being separated from the button by the discharge pressure of a liquid material, the discharge opening/closing part preferably further includes a separation prevention member, which has a separation prevention plate having a prevention plate discharge guide hole formed therethrough and is detachably coupled to the button such that the separation prevention plate is in close contact with the elastic deformation opening/closing part at the front of the elastic deformation opening/closing part, and the prevention plate discharge guide hole is aligned with the opening/closing cutting line.

In addition, in order to easily couple the separation prevention member to the button, the button preferably includes a button side part having a tube shape, and a button ceiling part which is formed at the upper end of the button side part and has a pair of fastening long holes formed through so as to be side by side to each other; and the separation prevention member preferably further includes a cover plate configured to extend from the upper end of the separation prevention plate so as to be perpendicular to the separation prevention plate, and a pair of fastening protrusions which are formed on the lower surface of the cover plate and have a length section shorter than the fastening long holes, and is coupled to the button such that the fastening protrusions are inserted into the fastening long holes.

In addition, in order to easily couple the fastening protrusions to the fastening long holes, the button ceiling part preferably has a fastening guide surface formed in an area of the upper surface thereof between the fastening long holes and dented to be inclined downward in a direction away from the elastic deformation opening/closing part.

Therefore, according to the present disclosure, the discharge opening/closing part is configured such that the elastic deformation opening/closing part, which is made of an elastic material and has the opening/closing cutting line formed thereon, closes the end of the button discharge channel part. Accordingly, the button can be pressed toward the cylinder with a reduced force, and the discharge opening/closing part can be easily assembled.

The button can be pressed with a reduced force because the button discharge channel part is opened as the area around the opening/closing cutting line is bent backward in the same direction as the direction in which the liquid material is discharged. The discharge opening/closing part can be easily assembled because the discharge opening/closing part is installed on the outer part of the horizontal discharge channel part.

### BRIEF DESCRIPTION OF THE DRAWINGS

FIG. 1 is a perspective view of a pumping-type container according to an embodiment of the present disclosure;

FIG. 2 and FIG. 3 are exploded perspective views of a pumping-type container according to an embodiment of the present disclosure;

FIG. 4 is a front view and a plan view of a pumping-type container according to an embodiment of the present disclosure;

FIG. 5 is a cross-sectional view taken along line 5-5 of FIG. 4;

FIG. 6 is a cross-sectional view taken along line 6-6 of FIG. 4;

FIG. 7 is a view showing a state in which a discharge opening/closing member is coupled to a button according to an embodiment of the present disclosure;

FIG. 8 is a view showing a button according to an embodiment of the present disclosure;

FIG. 9 is a view showing a discharge opening/closing member according to an embodiment of the present disclosure;

FIG. 10 is a cross-sectional view taken along line 10-10 of FIG. 9;

FIG. 11 is a view showing a separation prevention member according to an embodiment of the present disclosure;

FIG. 12 is a view showing an external container partition wall part according to an embodiment of the present disclosure;

FIG. 13 is a view showing a cylinder support member according to an embodiment of the present disclosure;

FIG. 14 is a view showing an external container shoulder part according to an embodiment of the present disclosure;

FIG. 15 is a view showing a check valve according to an embodiment of the present disclosure;

FIG. 16 is a view for explaining an operation of a pumping-type container according to an embodiment of the present disclosure;

FIG. 17 is a cross-sectional view of a pumping-type container according to another embodiment of the present disclosure;

FIG. 18 and FIG. 19 are main part cross-sectional views of a conventional pumping-type container;

FIG. 20 is a view showing a nozzle tube and a discharge opening/closing part according to a conventional pumping-type container; and

FIG. 21 is a view for explaining an operation of a conventional pumping-type container.

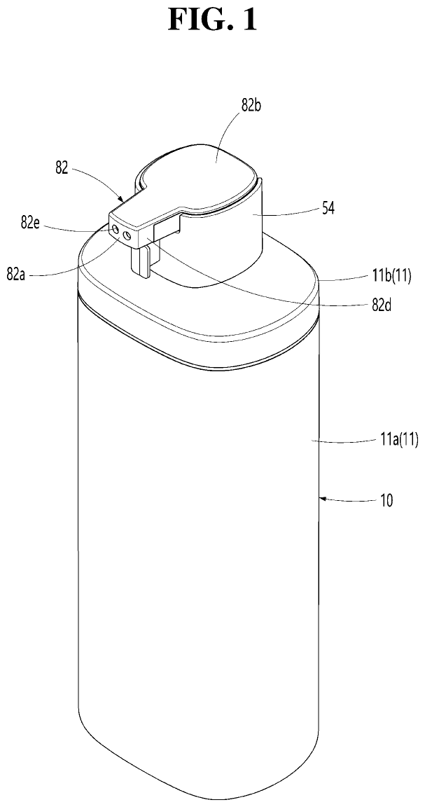

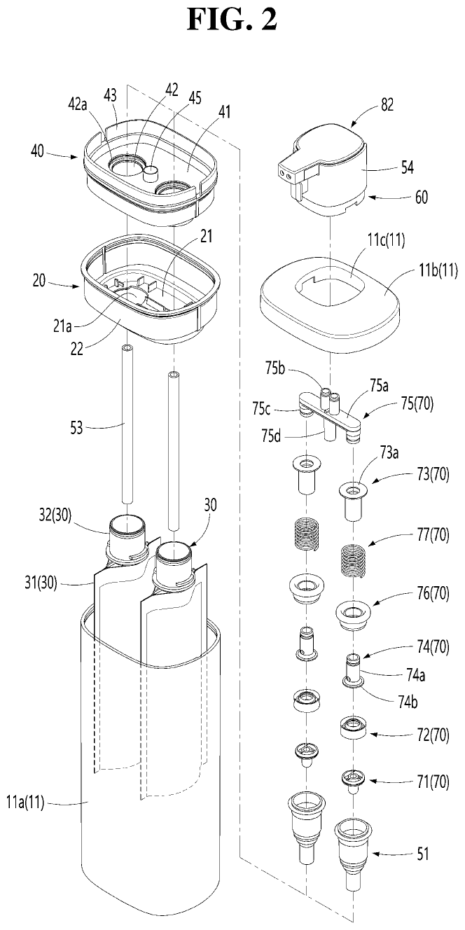

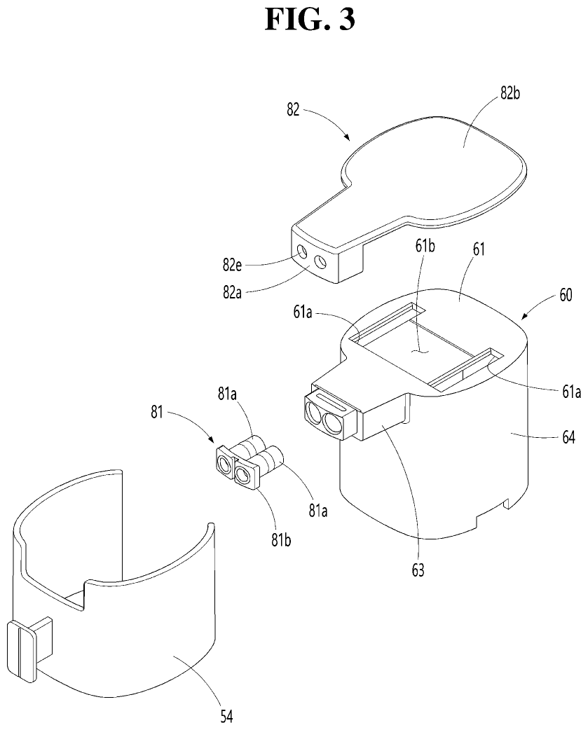

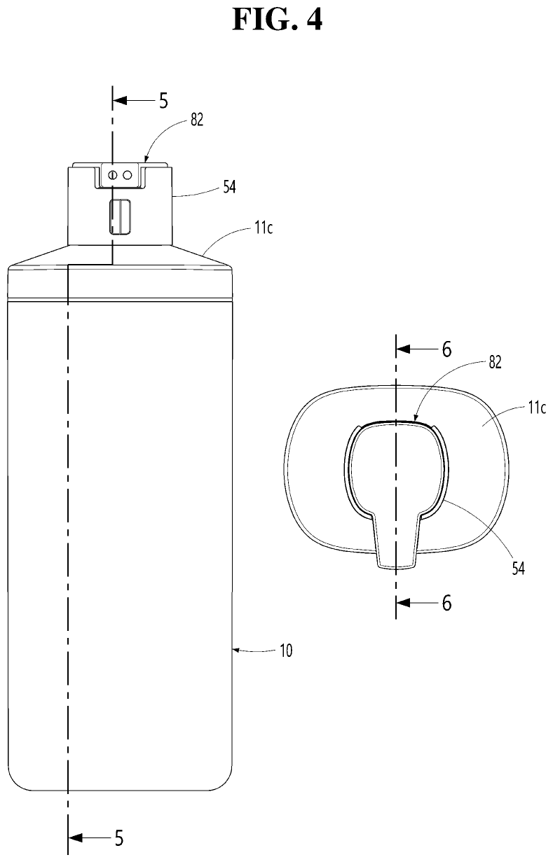

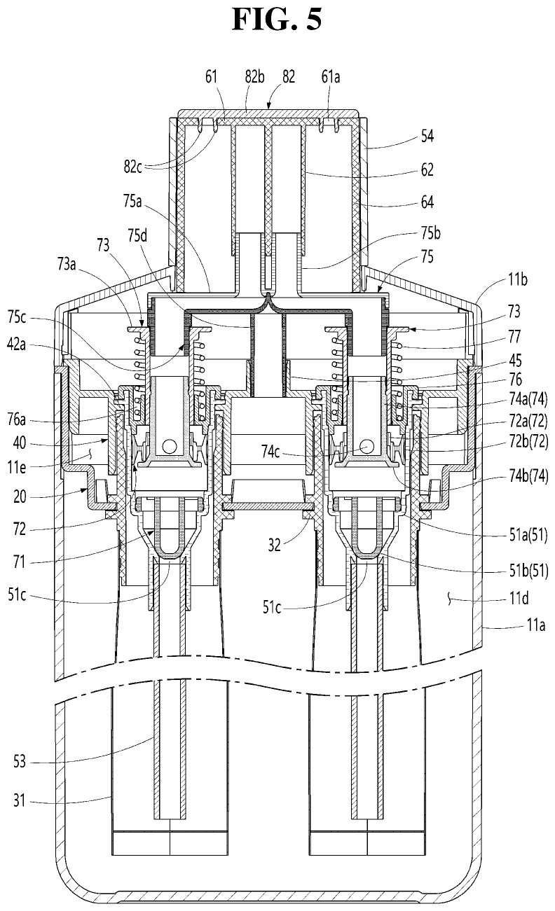

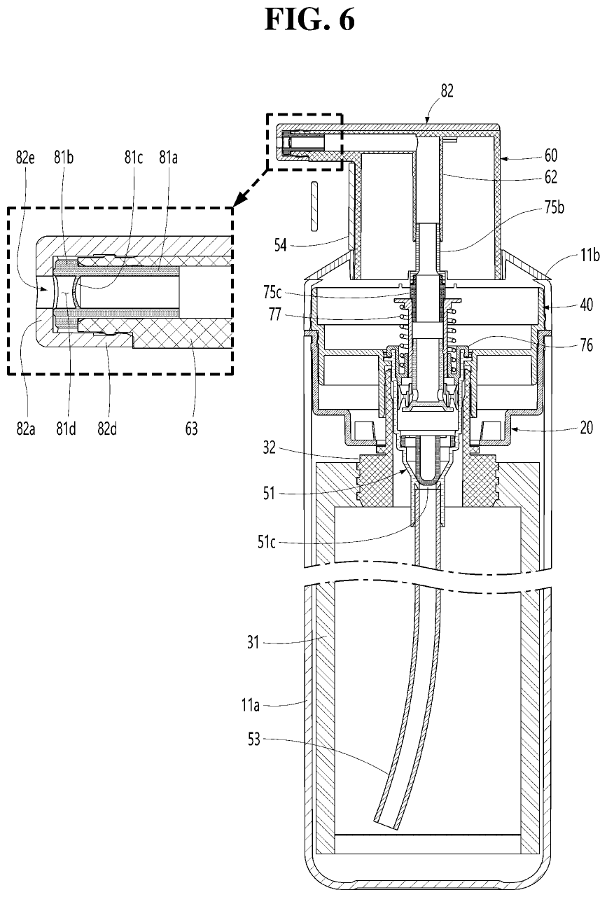

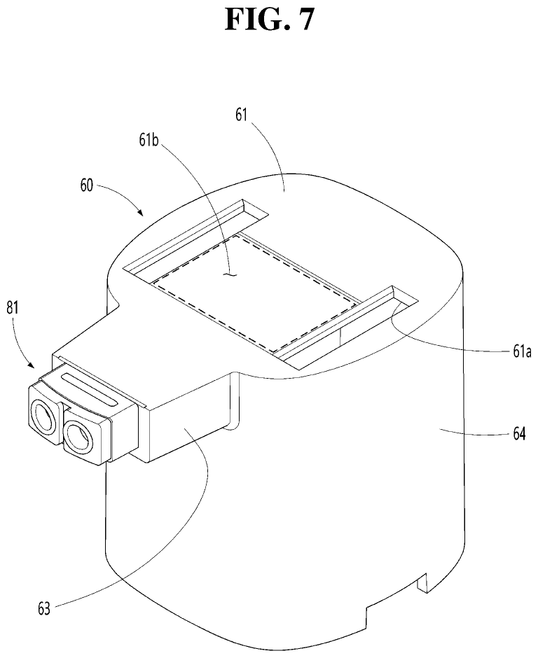

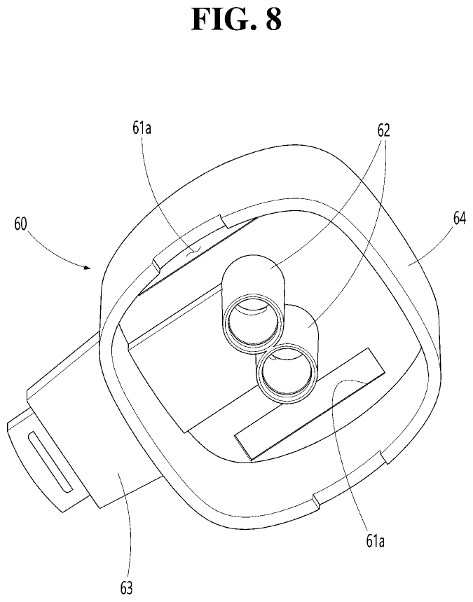

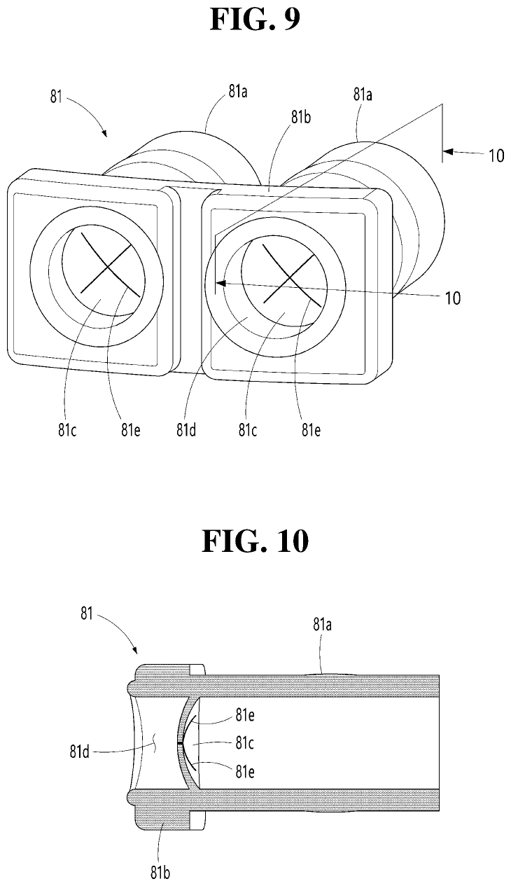

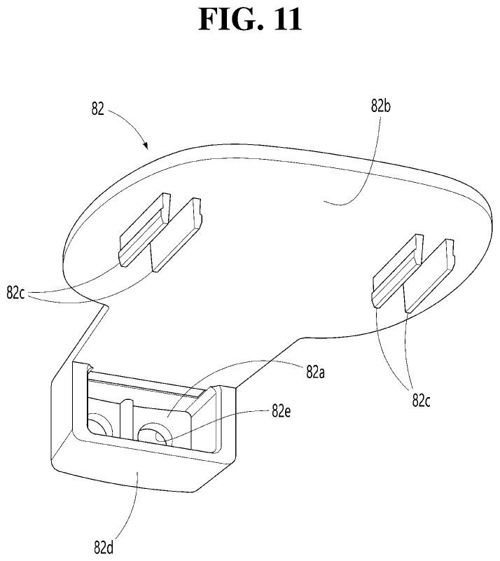

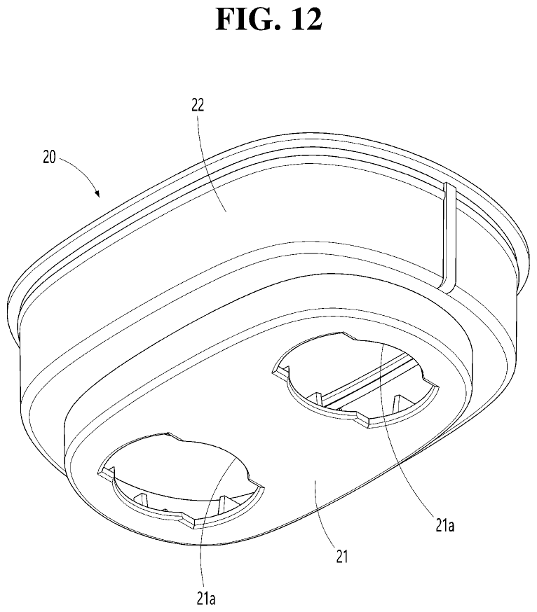

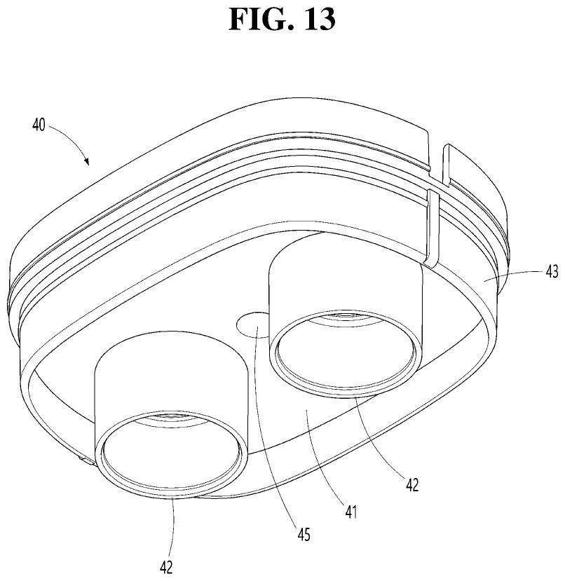

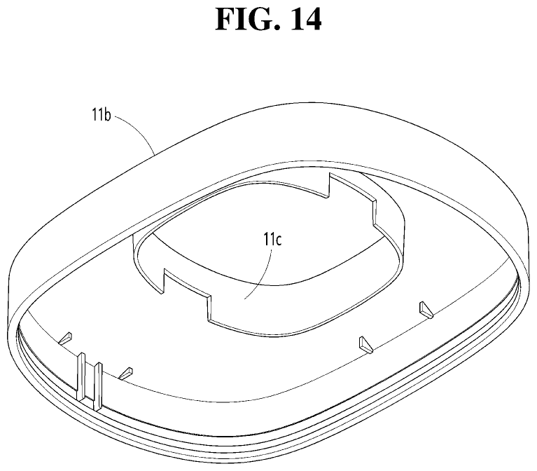

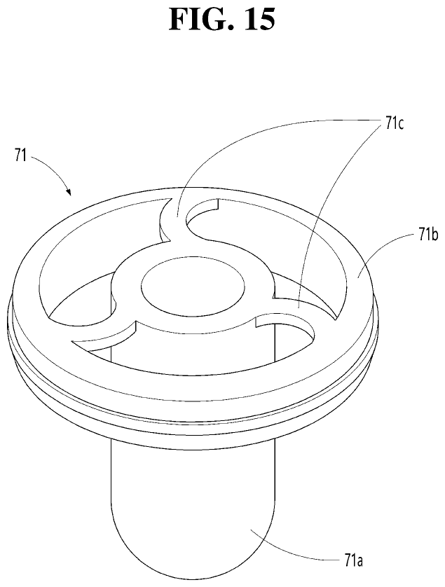

### DETAILED DESCRIPTION OF THE EXEMPLARY EMBODIMENTS

Hereinafter, the present disclosure will be described in detail with reference to the accompanying drawings.

A pumping-type container according to an embodiment of the present disclosure may be configured to have a container part 10 in which a liquid material is stored, a cylinder 51 installed in the container part 10, a button 60 which has a button discharge channel part formed therein and is installed in the container part 10 to be able to descend toward the cylinder 51, a pumping part 70 configured to operate such that the liquid material stored in the container part 10 is discharged to the outside through the button discharge channel part, a discharge opening/closing part 80 configured to operate so as to open or close the button discharge channel part, a tube 53 coupled to the lower end of the cylinder 51, and a button holder 54 coupled to the button 60.

The container part 10 may be configured to have an external container 11, an external container partition wall part 20 installed inside the external container 11 so as to partition the inner space of the external container 11 into an external container lower space 11d and an external container upper space 11e, and two liquid material storage containers 30 installed in the external container lower space 11d.

The external container 11 may be configured to have an external container body part 11a having a concave shape, an external container shoulder part lib installed on the upper end of the external container body part 11a, and a button raising/lowering guide tube part 11c formed on the upper end of the external container shoulder part 11b.

The external container partition wall part 20 may be configured to have a partition wall bottom part 21 having a pair of partition wall part communication holes 21a formed therethrough, and a partition wall part side part 22 formed to be bent upward from the peripheral circumferential part of the partition wall bottom part 21.

Each of the liquid material storage containers 30 may be configured to have a storage space part 31 having a storage space for the liquid material, and a storage container neck part 32 which has a tube shape and is coupled to the upper end of the storage space part 31 such that the lower end thereof communicates with the inner space of the storage space part 31.

Each of the liquid material storage containers 30 may be installed in the external container lower space 11d so as to be exposed to the external container upper space 11e by the following method.

First, the storage container neck part 32 may be passed through the partition wall part communication hole 21a, and then the liquid material storage container 30 may be rotated to couple the liquid material storage container 30 to the external container partition wall part 20.

Next, the external container partition wall part 20 may be coupled to the external container body part 11a such that the storage space part 31 is inserted into the external container lower space 11d.

The cylinder 51 may be installed inside each of the liquid material storage containers 30.

Each cylinder 51 may be configured to have a cylinder bottom part 51a having a through-hole 51c formed therethrough, and a cylinder side part 51b which has a tube shape and is formed to be bent from the peripheral circumferential part of the cylinder bottom part 51a.

The cylinder 51 may be installed inside the liquid material storage container 30 such that the through-hole 51c communicates with the inside of the storage space part 31.

Each cylinder 51 may be supported by a cylinder support member 40.

The cylinder support member 40 may be configured to have a cylinder support plate part 41, a pair of cylinder support tube parts 42 formed on the cylinder support plate part 41 so as to be vertically disposed on a plate surface of the cylinder support plate part 41, a fastening wall part 43 formed to extend from the cylinder support plate part 41 so as to surround the pair of cylinder support tube parts 42, and a movement prevention tube part 45 formed to extend upward along a direction perpendicular to the plate surface of the cylinder support plate part 41 in an area between the pair of cylinder support tube parts 42.

Each of the cylinder support tube parts 42 may have a cylinder support protrusion 42a formed to protrude from the upper end of the inner surface thereof.

The cylinder support member 40 may be coupled to the inner surface of the partition wall part side part 22 through the outer surface of the fastening wall part 43, and may be installed to be coupled to the outer surface of the storage container neck part 32 through the inner surface of the cylinder support tube part 42.

The cylinder 51 may be installed to be supported on the cylinder support protrusion 42a through the upper end of the cylinder side part 51b.

The button 60 may be configured to have a button side part 64 having a tube shape and a button ceiling part 61 formed at the upper end of the button side part 64 in addition to the button discharge channel part.

The button ceiling part 61 may have a pair of fastening long holes 61a formed therethrough to be side by side to each other.

In addition, the button ceiling part 61 may have a fastening guide surface 61b formed in an area of the upper surface thereof, which is between the fastening long holes 61a, and the fastening guide surface 61b may be formed to be dented and be inclined downward in a direction away from the elastic deformation opening/closing part 81c to be described later.

The button discharge channel part may be configured to have a horizontal discharge channel part 63 and a vertical discharge channel part 62 formed on the button ceiling part 61.

The vertical discharge channel part 62 may be provided to correspond to the liquid material storage container 30 one-to-one.

Each vertical discharge channel part 62 may be formed to be disposed side by side with the button side part 64.

The horizontal discharge channel part 63 may have one end configured to protrude beyond the outer surface of the button side part 64, and the other end formed to be connected to the upper end of each vertical discharge channel part 62.

The button 60 may be installed such that the lower end of the button side part 64 is inserted into the button raising/lowering guide tube part 11c.

The pumping part 70 may be configured to have a check valve 71 and a cylinder piston 72 installed inside the cylinder 51, a pressing member 73 installed above the cylinder piston 72, an opening/closing operation member 74 installed inside the pressing member 73, a discharge intermediate channel part 75 configured to connect the vertical discharge channel part 62 and the inner space of the cylinder 51, a spring support member 76 coupled to the cylinder 51, and a button return spring 77 installed between the button 60 and spring support member 76.

The check valve 71 may be configured to have a check valve opening/closing part 71a having a closed lower end and a circular tube shape, a support ring 71b which is disposed to surround the upper side of the check valve opening/closing part 71a and has a circular shape, and three connecting arms 71c configured to connect the check valve opening/closing part 71a and the support ring 71b.

The check valve 71 may be installed inside the cylinder 51 such that the check valve opening/closing part 71a closes the through-hole 51c.

The cylinder piston 72 may have a cylinder piston close-contact part 72a having a tube shape, and a cylinder piston channel opening/closing part 72b which has a tube shape and is formed to extend from the inner surface of the cylinder piston close-contact part 72a so as to be disposed side by side with the cylinder piston close-contact part 72a.

The cylinder piston 72 may be installed inside the cylinder 51 such that the cylinder piston close-contact part 72a is in close contact with the inner surface of the cylinder side part 51b.

The pressing member 73 may be formed to have a tube shape, and may have a spring support bent part 73a formed at the upper end thereof so as to extend to the outside.

The pressing member 73 may be coupled to a cylinder-side vertical channel part 75c to be described later.

The opening/closing operation member 74 may be configured to have an opening/closing operation tube part 74a having a closed lower end, and an opening/closing skirt part 74b formed to extend outward from the lower end of the opening/closing operation tube part 74a and to be inclined downward.

The opening/closing operation tube part 74a may have an operation tube discharge guide hole 74c formed through the lower end thereof.

The opening/closing operation member 74 may be coupled to the pressing member 73 such that the upper surface of the opening/closing skirt part 74b is in contact with the lower end of the cylinder piston channel opening/closing part 72b.

The discharge intermediate channel part 75 may be configured to have an intermediate horizontal channel part 75a, a pair of button-side vertical channel parts 75b formed to extend upward from the upper surface of the intermediate horizontal channel part 75a, a pair of cylinder-side vertical channel parts 75c formed to be respectively bent downward from both ends of the intermediate horizontal channel parts 75a, and a movement prevention column 75d formed to extend side by side with the cylinder-side vertical channel 75c from the lower surface of the intermediate horizontal channel part 75a.

The intermediate horizontal channel part 75a may have an upper part and a lower part which are separately manufactured and are then assembled together.

The discharge intermediate channel part 75 may be installed such that the button-side vertical channel 75b is connected to the vertical discharge channel part 62, and the movement prevention column 75d is inserted into the movement prevention tube part 45.

The spring support member 76 may have a spring support groove 76a formed thereon.

The button return spring 77 may be installed such that both ends thereof are supported by the bottom of the spring support groove 76a and the spring support bent part 73a, respectively.

The discharge opening/closing part 80 may be configured to have a discharge opening/closing member 81 and a separation prevention member 82 coupled to the button 60.

The discharge opening/closing member 81 may be configured to have a pair of opening/closing member support tube parts 81a, an opening/closing member support plate part 81b which is formed at the end of each of the opening/closing member support tube parts 81a so as to be disposed in a direction vertical to the longitudinal direction of the opening/closing member support tube part 81a and has a rectangular shape, and an elastic deformation opening/closing part 81c formed to close one end of each of opening/closing member support tube parts 81a.

The opening/closing member support plate part 81b may have a support plate discharge guide hole 81d formed in front of the elastic deformation opening/closing part 81c.

The elastic deformation opening/closing part 81c may have an opening/closing cutting line 81e formed thereon. The opening/closing cutting line 81e may be formed in an X-shape or the like.

The discharge opening/closing member 81 may be made of an elastic material such as nitrile-butadiene rubber (NBR).

The discharge opening/closing member 81 may be installed such that the opening/closing member support tube part 81a is inserted into the horizontal discharge channel part 63, and the elastic deformation opening/closing part 81c closes the end of the horizontal discharge channel part 63.

The separation prevention member 82 may be configured to have a separation prevention plate 82a through which a prevention plate discharge guide hole 82e is formed, a cover plate 82b formed to extend from the upper end of the separation prevention plate 82a so as to be perpendicular to the separation prevention plate 82a, a pair of fastening protrusions 82c formed on the lower surface of the cover plate 82b so as to correspond to each of the fastening long holes 61a, respectively, and a cover surface part 82d which is formed to extend from the separation prevention plate 82a and has a cross-section having the shape of letter “ [symbol] ”.

Each of the fastening protrusion 82c may include two divided parts.

The fastening protrusions 82c may be formed to have a length shorter than that of each of the fastening long holes 61a.

The separation prevention member 82 may be connected to the button 60 such that the separation prevention plate 82a is disposed in front of the elastic deformation opening/closing part 81c and is in close contact with the elastic deformation opening/closing part 81c, and each of the prevention plate discharge guide hole 82e is aligned with the opening/closing cutting line 81e. The coupling of the separation prevention member 82 may be achieved by inserting the fastening protrusions 82c into each of the fastening long holes 61a. The initial insertion depth of the fastening protrusions 82c with respect to each of the fastening long holes 61a may be increased due to the fastening guide surface 61b.

The tube 53 may be coupled to the cylinder 51 such that the upper end thereof is connected to the through-hole 51c.

The button holder 54 may be configured to function such that the button 60 is prevented from being unintentionally pressed toward the cylinder 51 during distribution or storage.

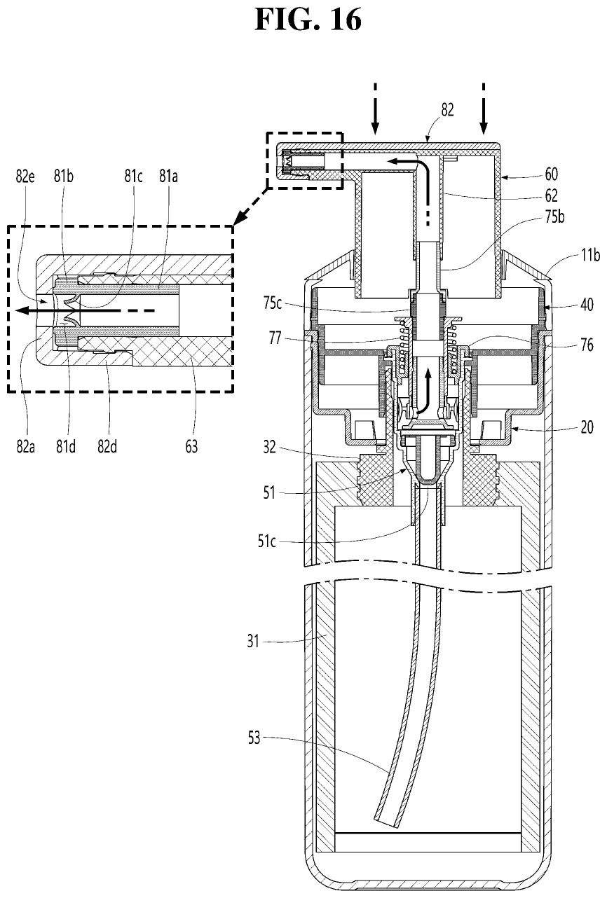

A method of using the pumping-type container having the above-described configuration according to an embodiment of the present disclosure will be described with reference to FIG. 16 as follows. Since the operating principle of the pumping part 70 is well known in the prior art, it will be briefly described.

First, the button holder 54 is separated from the button side part 64.

Next, the button 60 is pressed and thus descended toward the cylinder 51. In this case, the button return spring 77 has an accumulated elastic force while the button 60 is descended.

And then, when the button 60 is descended, by the following operations, the through-hole 51c is closed, the elastic deformation opening/closing part 81c is opened, and the liquid material stored in each cylinder 51 is discharged to the outside.

1) The opening/closing operation member 74 begins to descend together with the button 60, and the cylinder piston 72 begins to descend later than the opening/closing operation member 74.

2) As the cylinder piston 72 is descended later than the opening/closing operation member 74, the portion between the opening/closing skirt part 74b and the cylinder piston channel opening/closing part 72b is opened.

3) And then, as the cylinder piston 72 is descended, the inside of each cylinder 51 becomes a positive pressure state.

When the inside of the cylinder 51 becomes a positive pressure state, the through-hole 51c is closed by the check valve 71, the liquid material stored in the cylinder 51 reaches the elastic deformation opening/closing part 81c through the opening/closing operation member 74, the pressing member 73, the discharge intermediate channel part 75, the vertical button channel part 62, and the horizontal button channel part 63.

By the discharge pressure of the liquid material having reached the elastic deformation opening/closing part 81c, the area around the opening/closing cutting line 81e is bent backward and thus the elastic deformation opening/closing part 81c is opened (see FIG. 16).

When the elastic deformation opening/closing part 81c is opened, the liquid material having reached the elastic deformation opening/closing part 81c is discharged to the outside.

Next, the operation of pressing the button 60 is stopped.

When the operation of pressing the button 60 is stopped, the button 60 is ascended by the elastic force accumulated in the button return spring 77.

While button 60 ascends, by the following operations, the through-hole 51c is opened, the liquid material stored in each of the liquid material storage containers 30 is introduced into each cylinder 51 through the through-hole 51c, and the elastic deformation opening/closing part 81c is closed.

1) The opening/closing operation member 74 begins to ascend together with the button 60, and the cylinder piston 72 begins to ascend later than the opening/closing operation member 74.

2) As the cylinder piston 72 ascends later than the opening/closing operation member 74, the portion between the opening/closing skirt part 74b and the cylinder piston channel opening/closing part 72b is closed.

3) And then, as the cylinder piston 72 ascends, the inside of each cylinder 51 becomes in a negative pressure state.

4) When the inside of the cylinder 51 becomes a negative pressure state, the through-hole 51c is opened, and thus the liquid material stored in the liquid material storage container 30 is introduced into the cylinder 51 through the through-hole 51c.

While the liquid material stored in the storage space part 31 is introduced into the cylinder 51, the volume of the storage space part 31 is reduced.

In addition, when the inside of the cylinder 51 becomes a negative pressure state, the discharge operation of the liquid material is stopped.

When the discharge operation of the liquid material is stopped, the bent state of the area around the opening/closing cutting line 81e vanishes, and thus the elastic deformation opening/closing part 81c is closed back.

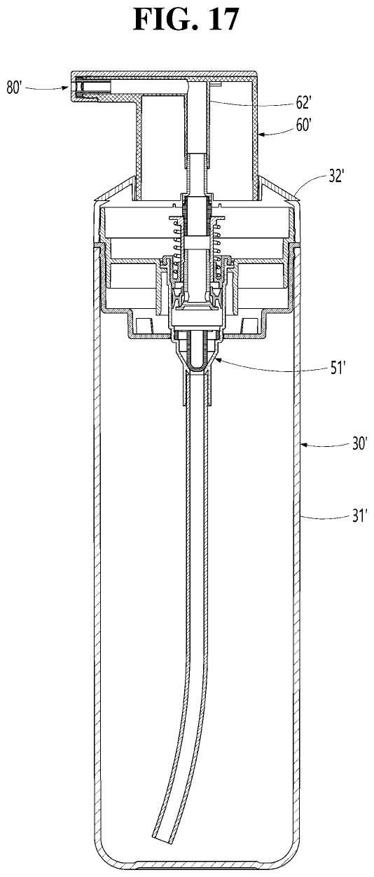

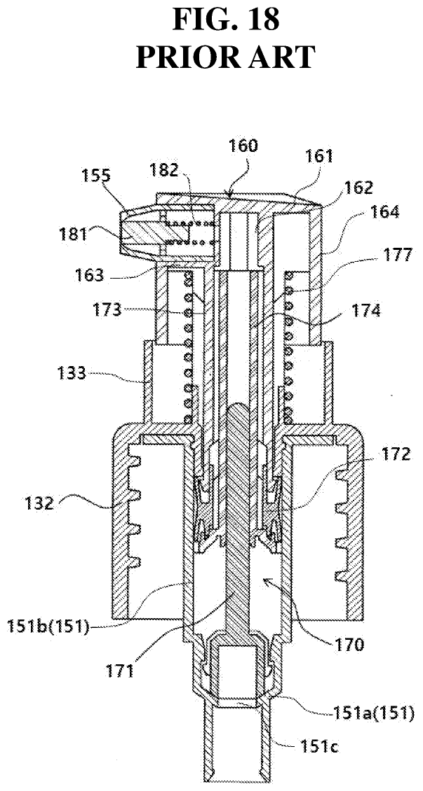

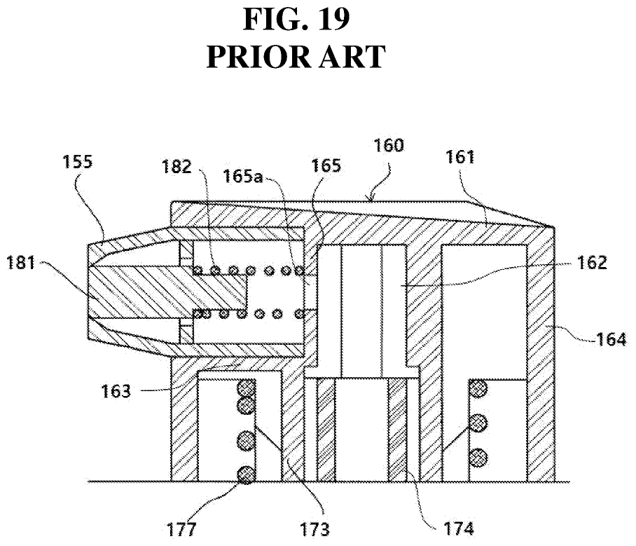

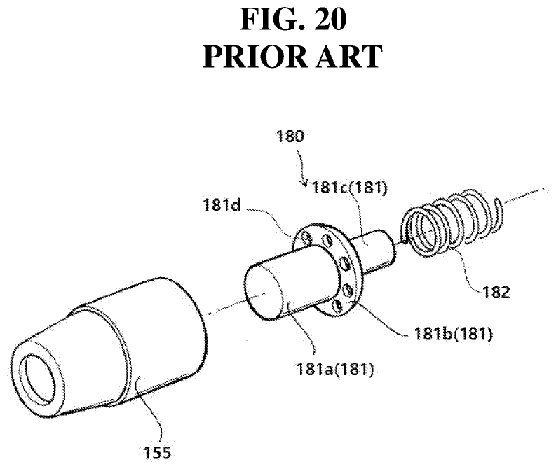

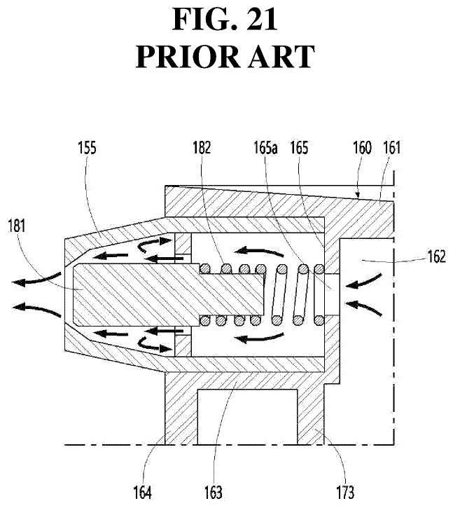

Meanwhile, in the above-described embodiment, although the container part 10 is configured to have multiple the liquid material storage containers 30, as illustrated in FIG. 17, the container part configured to have one liquid material storage container can also be applied to the present disclosure.

FIG. 17 is a cross-sectional view of a pumping-type container according to another embodiment of the present disclosure.

A pumping-type container according to another embodiment of the present disclosure may be configured to have one liquid material storage container 30′ and one cylinder 51′.

The liquid material storage container 30′ may be configured to have a storage space part 31′ having a concave shape and a storage container shoulder part 32′ installed on the upper end of the storage space part 31′.

As in the case of the pumping-type container according to an embodiment of the present disclosure, the storage space part 31′ may be made of a material which enables the volume of the inner space thereof to be reduced, and otherwise, a means for, when a liquid material stored in the liquid material storage container 30′ is introduced into the cylinder 51′, introducing air into the storage space part 31′, may be added thereto so as to implement the present disclosure. Since the means for introducing air into the storage space part 31′ is well known in the prior art, detailed descriptions thereof will be omitted (see Korea Patent Registration No. 10-1959131, Korea Utility Model Publication No. 20-2014-0002216, etc.).

A button 60′ may have one vertical discharge channel part 62′ formed therein.

A discharge opening/closing part 80′ may be configured to have the same configuration as that of the pumping-type container according to an embodiment of the present disclosure.

As described above, according to the present disclosure, the discharge opening/closing part 80 may be configured such that the elastic deformation opening/closing part 81c, which is made of an elastic material and has the opening/closing cutting line 81e formed thereon, closes the end of each of the button discharge channel parts 62 and 63, so that the force of pressing the button 60 toward the cylinder 51 is reduced, and the assembly operation of the discharge opening/closing part 80 is facilitated.

The reason why the force of pressing the button 60 is reduced, is that the button discharge channel parts 62 and 63 are opened as the area around the opening/closing cutting line 81e is bent in the same direction as the direction in which the liquid material is discharged. In addition, the reason why the assembly operation of the discharge opening/closing part 80 is facilitated, is that the discharge opening/closing part 80 is installed on the outer part of the horizontal discharge channel part 63.

In addition, the separation prevention member 82 is coupled to the button 60 such that the separation prevention plate 82a is in close contact with the elastic deformation opening/closing part 81c in the front of the elastic deformation opening/closing part 81c so that the discharge opening/closing member 81 is prevented from being separated from the button 60 by the discharge pressure of the liquid material.

In addition, the pair of fastening protrusions 82c formed on the separation prevention member 82 are inserted into each of the pair of fastening long holes 61a formed through the button 60 so as to couple the separation prevention member 82 to the button 60, thereby easily coupling the separation prevention member 82 to the button 60. The reason why the separation prevention member 82 is easily coupled to the button 60, is that the separation prevention member 82 is coupled to the button 60 by the operation of sliding the separation prevention member 82 on the upper surface of the button ceiling part 61.

In addition, the fastening guide surface 61b is formed on the button ceiling part 61 so as to have a downward inclination in the direction away from the elastic deformation opening/closing part 81c, so that the fastening protrusions 82c are easily inserted into each of the fastening long holes 61a. The reason why the fastening protrusions 82c are easily inserted into each of the fastening long holes 61a, is that the initial insertion depth of the fastening protrusions 82c with respect to each of the fastening long holes 61a is increased.

In addition, the cylinder 51, which has the same number as the liquid material storage container 30, may be installed therein, and the pumping part 70 may be configured such that the liquid material stored in each cylinder 51 is discharged to the outside through each of the button discharge channel parts 62 and 63 when the button 60 is descended, and the liquid material stored in each liquid material storage container 30 is introduced into each cylinder 51 when the button 60 ascends to the original position thereof. Therefore, the present disclosure may also be applied to a pumping-type container having multiple liquid material storage containers 30.

What is claimed is:

1. A pumping-type container comprising:
a container part in which a liquid material is stored;
a cylinder installed inside the container part;
a button configured to have a button discharge channel part formed therein and installed in the container part to be able to descend toward the cylinder;
a pumping part configured to operate such that the liquid material in the cylinder is discharged to the outside through the button discharge channel part when the button descends toward the cylinder, and the liquid material stored in the container part is introduced into the cylinder when the button ascends to the original position thereof; and
a discharge opening/closing part configured to operate so as to open the button discharge channel part when the liquid material is discharged to the outside through the button discharge channel part and to close the button discharge channel part when discharge of the liquid material through the button discharge channel part is stopped, wherein
the discharge opening/closing part has an elastic deformation opening/closing part which is made of an elastic material and has an opening/closing cutting line formed thereon, and is detachably coupled to the button such that the elastic deformation opening/closing part closes the end of the button discharge channel part.

2. The pumping-type container of claim 1, wherein the discharge opening/closing part further comprises a separation prevention member which has a separation prevention plate having a prevention plate discharge guide hole formed therethrough, and is detachably coupled to the button such that the separation prevention plate is in close contact with the elastic deformation opening/closing part at the front of the elastic deformation opening/closing part, and the prevention plate discharge guide hole is aligned with the opening/closing cutting line.

3. The pumping-type container of claim 2, wherein the button comprises a button side part having a tube shape and a button ceiling part which is formed at the upper end of the button side part and has a pair of fastening long holes formed through so as to be side by side to each other; and
the separation prevention member further comprises a cover plate configured to extend from the upper end of the separation prevention plate so as to be perpendicular to the separation prevention plate, and a pair of fastening protrusions which are formed on the lower surface of the cover plate and have a length section shorter than the fastening long holes, and is coupled to the button such that the fastening protrusions are inserted into the fastening long holes.

4. The pumping-type container of claim 3, wherein the button ceiling part has a fastening guide surface formed in an area of the upper surface thereof between the fastening long holes and dented to be inclined downward in a direction away from the elastic deformation opening/closing part.

5. The pumping-type container of claim 1, wherein the container part comprises an external container having a button raising/lowering guide tube part formed in the upper end thereof, an external container partition wall part installed inside the external container so as to partition the inner space of the external container into an external container lower space and an external container upper space, and multiple liquid material storage containers installed in the external container lower space so as to be exposed to the external container upper space;
the cylinder is installed inside each of the liquid material storage containers;
the button is installed in the container part to be able to ascend or descend along the button raising/lowering guide tube part; and
the pumping part is configured to operate such that the liquid material in each cylinder is discharged to the outside through the button discharge channel part when the button is descended, and the liquid material stored in each of the liquid material storage containers is introduced into each cylinder when the button ascends to the original position thereof.

6. The pumping-type container of claim 2, wherein the container part comprises an external container having a button raising/lowering guide tube part formed in the upper end thereof, an external container partition wall part installed inside the external container so as to partition the inner space of the external container into an external container lower space and an external container upper space, and multiple liquid material storage containers installed in the external container lower space—so as to be exposed to the external container upper space;
the cylinder is installed inside each of the liquid material storage containers;
the button is installed in the container part to be able to ascend or descend along the button raising/lowering guide tube part; and
the pumping part is configured to operate such that the liquid material in each cylinder is discharged to the outside through the button discharge channel part when the button is descended, and the liquid material stored in each of the liquid material storage containers is introduced into each cylinder when the button ascends to the original position thereof.

7. The pumping-type container of claim 3, wherein the container part comprises an external container having a button raising/lowering guide tube part formed in the upper end thereof, an external container partition wall part installed inside the external container so as to partition the inner space of the external container into an external container lower space and an external container upper space, and multiple liquid material storage containers installed in the external container lower space—so as to be exposed to the external container upper space;
the cylinder is installed inside each of the liquid material storage containers;
the button is installed in the container part to be able to ascend or descend along the button raising/lowering guide tube part; and
the pumping part is configured to operate such that the liquid material in each cylinder is discharged to the outside through the button discharge channel part when the button is descended, and the liquid material stored in each of the liquid material storage containers is introduced into each cylinder when the button ascends to the original position thereof.

8. The pumping-type container of claim 4, wherein the container part comprises an external container having a button raising/lowering guide tube part formed in the upper end thereof, an external container partition wall part installed inside the external container so as to partition the inner space of the external container into an external container lower space and an external container upper space, and multiple liquid material storage containers installed in the external container lower space so as to be exposed to the external container upper space;
the cylinder is installed inside each of the liquid material storage containers;
the button is installed in the container part to be able to ascend or descend along the button raising/lowering guide tube part; and
the pumping part is configured to operate such that the liquid material in each cylinder is discharged to the outside through the button discharge channel part when the button is descended, and the liquid material stored in each of the liquid material storage containers is introduced into each cylinder when the button ascends to the original position thereof.
